(19) United States
(12) Patent Application Publication
(10) Pub. No.: US 2009/0267841 A1
(43) Pub. Date: Oct. 29, 2009

(54) ASSEMBLED FILM ANTENNA STRUCTURE

(75) Inventors: Chia-Yu LIAO, Jhongli City (TW); Yuan-Ming CHANG, Foungyuan City (TW)

Correspondence Address: EGBERT LAW OFFICES, 412 MAIN STREET, 7TH FLOOR, HOUSTON, TX, 77002, US

(73) Assignee: PARAGON TECHNOLOGIES, Co., Ltd., Yingge Township (TW)

(21) Appl. No.: 12/255,477

(22) Filed: Oct. 21, 2008

Related U.S. Application Data
(63) Continuation-in-part of application No. 12/111,038, filed on Apr. 28, 2008.

(51) Int. Cl. H01Q 1/38

(52) U.S. Cl. 343/700 MS

(57) ABSTRACT

The present invention provides an assembled film antenna structure. The antenna structure includes a substrate, a feeder and conductive medium. The substrate is provided with a conductive thin-profile antenna body. The antenna body includes a signal connector. One side of the conductive medium is connected with the feeder, and the other side is assembled and positioned securely onto the signal connector of antenna body. An anchor protrudes from one side of the conductive medium, and the anchor is embedded into the antenna body and substrate via hot pressing. Thus, the conductive medium and antenna body can be assembled in a more simple and fast way, generating an improved applicability and industrial efficiency.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a film antenna, and more particularly to an innovative film antenna with an antenna body and feeder in a combined configuration.

2. Description of Related Art Including Information Disclosed Under 37 CFR 1.97 and 37 CFR 1.98

Conventional antennas are generally made of metal sheets by means of punching or extrusion. These antennas have three-dimension shapes; hence, the antennas occupy large spaces as a whole. They are unsuitable because of the prevailing thin-profile trend in the electronic products industry. Therefore, a film antenna is developed in keeping with this trend. A film antenna is fabricated by printing, vapor plating and sputtering onto a preset substrate of an electronic product, such as a circuit board, housing, etc., thus forming a thin-profile antenna structure. However, the feeding point and grounding portion of the antenna must be electrically connected with the core wire and external conductor of a coaxial cable (i.e. feeder) for the feeding of received and transmitted signals. For a solid antenna made of metal sheets, the antenna can be coupled with the coaxial cable by means of welding without any damage. As a film antenna is assembled onto the substrate, due to the raised temperature fusion or even damage of the film antenna, or the substrate may possibly occur if the film antenna and coaxial cable are welded together.

In view of the aforementioned conventional deficiencies, the inventor has disclosed a film antenna assembly structure, wherein the conductive film antenna body on the substrate is electrically connected with the feeder via a conductive medium. The corresponding method of fabricating the same is also disclosed. Thus, the electric connection problem between the feeder and film antenna is resolved.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

According to an aspect of the innovative present invention, an anchor is laterally arranged onto the conductive medium. The anchor is embedded into the antenna body and substrate by means of hot pressing. The conductive medium and antenna body can be assembled in a more simple, reliable, and fast way, thus generating improved applicability and industrial efficiency.

According to an aspect of the present invention with a protruding portion laterally arranged onto the conductive medium, a concave portion is arranged correspondingly onto the antenna body. Conductive adhesive is filled into the concave portion. The conductive medium and antenna body can be electrically connected and positioned more securely.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts an assembled perspective view of preferred embodiment of the present invention.

FIG. 2 depicts an exploded perspective view of the conductive medium and antenna body of the present invention.

FIG. 3 depicts an exploded sectional view of preferred embodiment of the present invention.

FIG. 4 depicts an assembled sectional view of preferred embodiment of the present invention.

FIG. 5 depicts another perspective view of a second preferred embodiment of an anchor of the present invention.

FIG. 6 depicts an assembled sectional view of the second preferred embodiment of the present invention.

FIG. 7 depicts an assembled sectional view of still another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

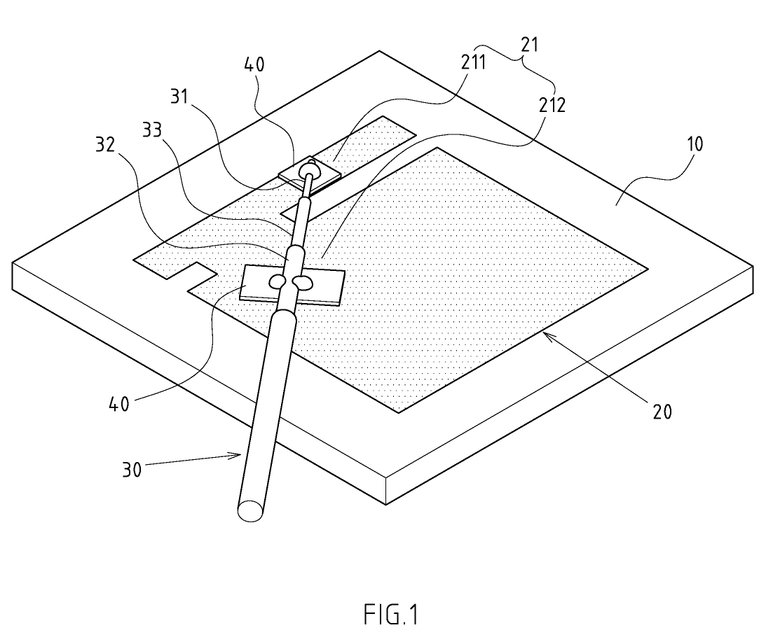

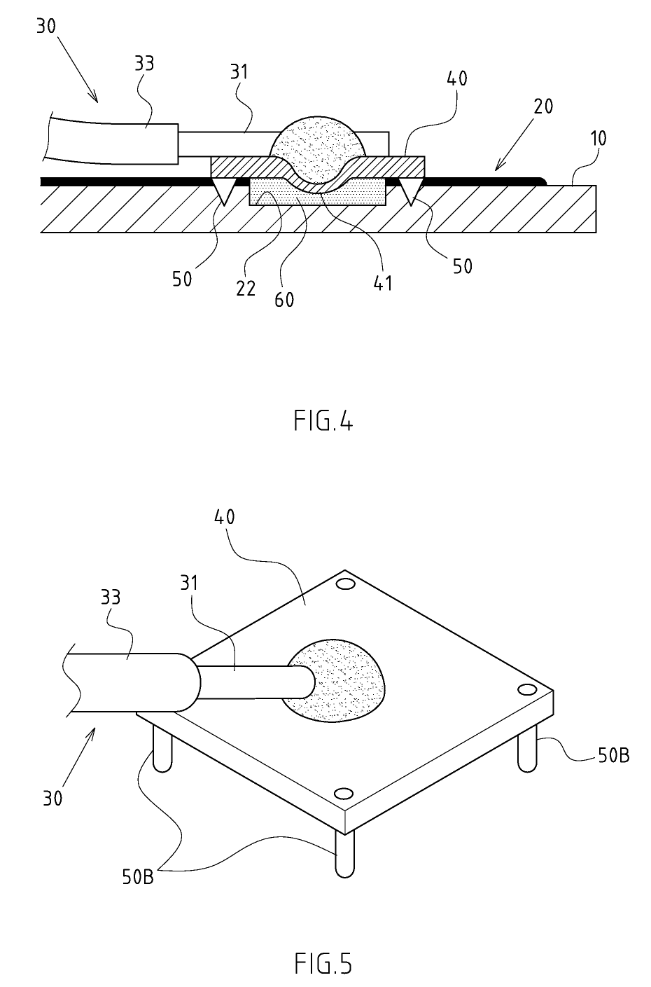

FIGS. 1-4 depict preferred embodiments of assembled film antenna structure of the present invention. The embodiments are provided only for explanatory purpose with respect to the patent claims.

The assembled film antenna structure comprises a substrate 10, which can be a housing portion or a rack part or others of circuit boards or electronic products.

An antenna body 20 is formed by a conductive thin-profile structure assembled onto the preset location of substrate 10. The antenna body 20 comprises a signal connector 21 including a signal feeding portion 211 and a signal grounding portion 212.

A feeder 30 is a coaxial cable including a core wire 31, an external conductor 32 and an intermediate insulating layer 33. The core wire of feeder 30 is used to connect the signal feeding portion 211 of signal connector 21 of antenna body 20. The external conductor 32 of feeder 30 is used to connect signal grounding portion 212 of signal connector 21 of antenna body 20.

A conductive medium 40 has one side connected with the feeder 30 and the other side assembled securely onto the signal connector 21 of antenna body 20.

A plurality of anchors 50 protrude from one side of the conductive medium 40. The anchor 50 is embedded into the antenna body 20 and substrate 10 by means of hot pressing; more specifically, the anchor 50 of conductive medium 40 is heated up to a high temperature, and then pressed forcibly into antenna body 20 and substrate 10. As the substrate 10 is generally made of plastic materials, and the antenna body 20 is of only a coated thin-profile structure, the heating and pressing of anchor 50 is not encountered with a solid resisting power. Thus, an inner concave may be shaped accordingly to cover tightly the anchor 50, enabling positioning of the conductive medium 40 and antenna body 20.

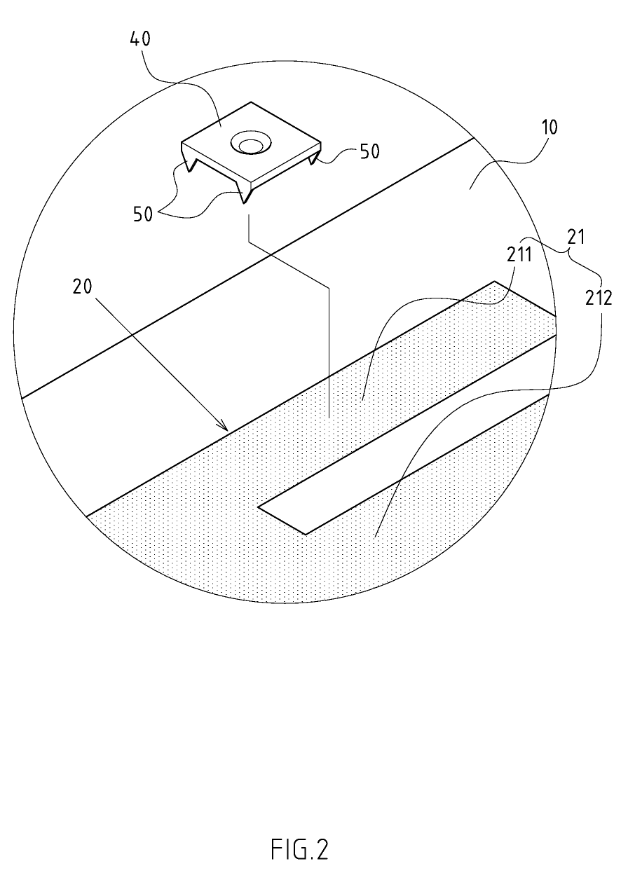

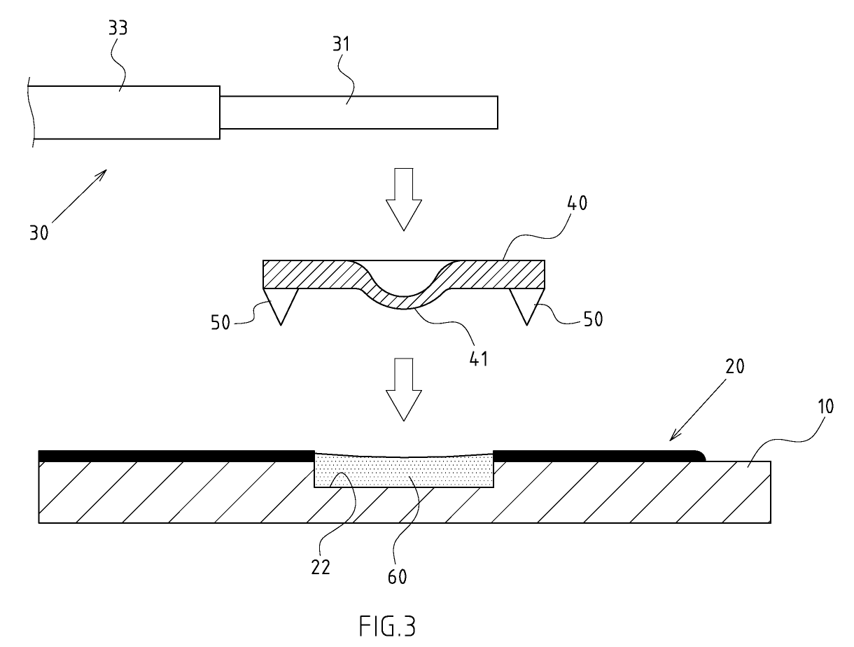

Referring to FIGS. 2-3, the anchor 50 is formed by the extended or bent convex body from the edge and/or lateral surface of the conductive medium 40; of course, a pyramidal tip of anchor 50 can be more smoothly embedded into the antenna body 20 and substrate 10. Referring to FIG. 5, the anchor 50B is formed by several columns arranged at interval onto one side of the conductive medium 40; the columnar anchor 50B can be inserted into the conductive medium 40, or prefabricated by the conductive medium 40.

Furthermore, the conductive medium 40 comprises a protruding portion 41 on the facing side corresponding to the antenna body 20. The antenna body 20 and substrate 10 are comprised of a larger-sized concave portion 22 for accommodating the protruding portion 41. Conductive adhesive 60 (e.g. silver colloid) is filled into the concave portion 22 to allow for adhesion and electrical connection of concave portion 22 and protruding portion 41. Moreover, the protruding portion 41 can be implemented by means of die punching. It is understood that the protruding portion 41 can also be implemented by other technical means, e.g. welding material.

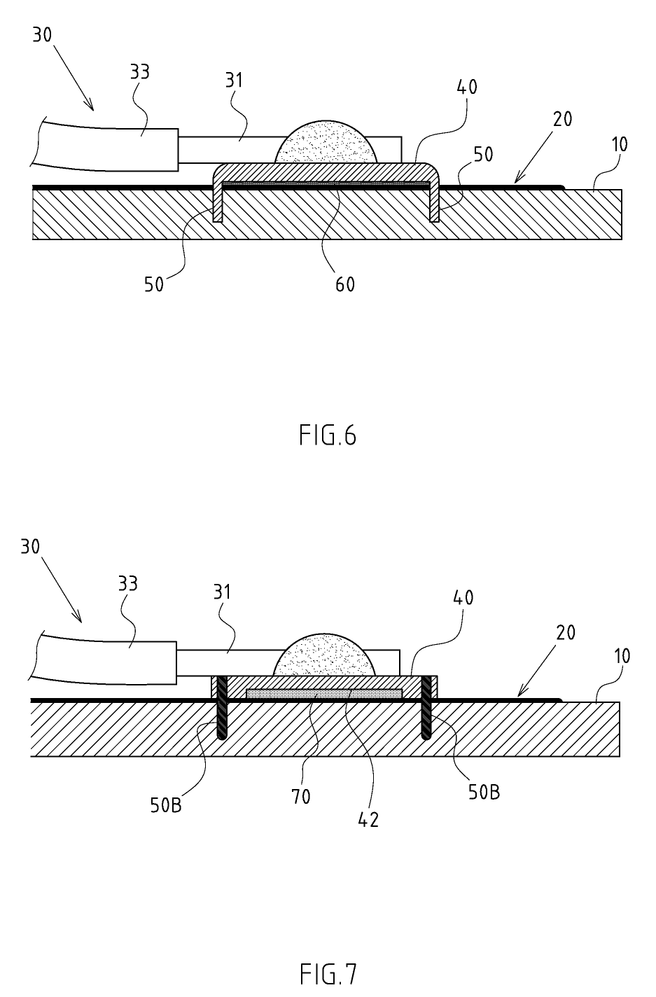

Referring to FIG. 6, conductive adhesive 60 (e.g. silver colloid) is coated onto the facing of the conductive medium 40 corresponding to the antenna body 20. The binding and electrical connection state of conductive medium 40 and antenna body 20 is improved.

Referring to FIG. 7, a recess 42 is arranged laterally onto a portion of the face of the conductive medium 40 corresponding to the antenna body 20. Adhesive agent 70 is then filled into the recess 42. In this preferred embodiment, the adhesive agent 70 can be a conductive or non-conductive adhesive. Since the conductive medium 40 and antenna body 20 have a contact for electrical connection, the adhesive agent 70, irrespective of conductive or non-conductive adhesive, functions as an assist with positioning.

I claim:

1. An assembled film antenna structure, comprising:
a substrate;
an antenna body, being comprised of a conductive thin-profile structure assembled onto said substrate, said antenna body being provided with a signal connector;
a feeder on said substrate;
a conductive medium, having one side connected with said feeder and another side assembled securely onto said signal connector of said antenna body; and
an anchor, protruding from one side of said conductive medium, said anchor being embedded into said antenna body and substrate via hot pressing.

2. The antenna structure defined in claim 1, wherein said anchor is formed by extending a convex body from an edge or lateral surface or both of the conductive medium.

3. The antenna structure defined in claim 1, wherein said anchor is comprised of columns arranged onto one side of the conductive medium.

4. The antenna structure defined in claim 1, wherein the conductive medium is provided with a protruding portion corresponding to the antenna body; wherein the antenna body and substrate are provided with an enlarged depressed portion accommodating said protruding portion, and wherein the depressed portion has conductive adhesive filled therein, forming adhesion and electrical connection of said depressed portion and said protruding portion.

5. The antenna structure defined in claim 1, wherein said conductive medium has conductive adhesive coated onto one side of said conductive medium corresponding to said antenna body.

6. The antenna structure defined in claim 1, wherein said conductive medium has a groove arranged laterally thereon, corresponding to said antenna body and an adhesive agent filling said groove and being adhesive.

7. The antenna structure defined in claim 1, wherein said signal connector contains a signal feeding portion and signal grounding portion.
